(19) United States
(12) Patent Application Publication
(10) Pub. No.: US 2007/0279749 A1
(43) Pub. Date: Dec. 6, 2007

(54) Structure and method for optical coating

(76) Inventors: Kuohua (Angus) Wu, Corvallis, OR (US); Stephan R. Clark, Corvallis, OR (US); Anurag Gupta, Tucson, AZ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/445,003

(22) Filed: May 31, 2006

(51) Int. Cl. G02B 1/10

(52) U.S. Cl. 359/584; 359/577

(57) ABSTRACT

A method and structure for an optical coating for a bounding interface between optical components is provided. The structure includes a first optical substrate having a substrate refractive index. A first dielectric coating layer can be applied to the first optical substrate and a second dielectric coating can be applied to the first dielectric coating layer. Then a third dielectric coating can be applied to the second dielectric coating layer.

### FIELD OF THE INVENTION

The present invention relates to optical coatings.

### BACKGROUND OF THE INVENTION

In recent years, there has been an increase in communication and information technologies that are being developed and introduced to society. As this technological area continues to develop and grow, there has also been an increase in the demand for optical technologies that help transmit, reproduce and display the information being stored or communicated by electronic information technologies.

In the communications arena, optical fiber technology is used to increase communication speeds across optical networks. Optical fiber technologies use specific compositions and coatings that are applied to optical substrates to provide the appropriate optical properties. In order to form optical devices with high quality optical coatings, the coating properties need to be specified accordingly.

Basic characteristics of optical materials include surface quality, material type, uniformity and optical quality. Optical quality refers to low levels of absorption, reflectance, and scattering loss to achieve desired levels of transmission. Optical quality also comprises the uniformity of optical properties, such as index-of-refraction and similar properties.

Another example of an area where information technologies have increased the need for high quality optical technologies is in the area of optical projectors. Such projectors are used to project presentations from desktop computers, laptops, and computer networks to audiences who desire to view stored information. Digital projectors use optical components for which it is desirable to have the qualities of low reflectance and tolerance insensitivity.

These digital projectors often use two or more lenses in their projection systems (e.g., doublets or triplets), and the lenses are joined together by optical cement. If the lenses are joined together by optical cement, this can create an optical properties mismatch between the lens (or optical substrate) and the optical cement due to their different optical indices. This mismatch may result in light noise or ghost light and create unexpected artifacts. In addition, the interface between the optical cement and the lens can cause significant light reflectance due to Fresnel reflection.

### BRIEF DESCRIPTION OF THE DRAWINGS

FIG. 1 illustrates that optical cement can be used between two optical substrates to create a bounding interface;

FIG. 2 illustrates a plurality of dielectric layers between an optical substrate and an optical cement in an embodiment;

FIG. 3 illustrates a plurality of dielectric layers between two optical substrates and the optical cement in an embodiment; and

FIG. 4 is a flow chart illustrating a method for manufacturing an optical coating structure for optical components.

### DETAILED DESCRIPTION

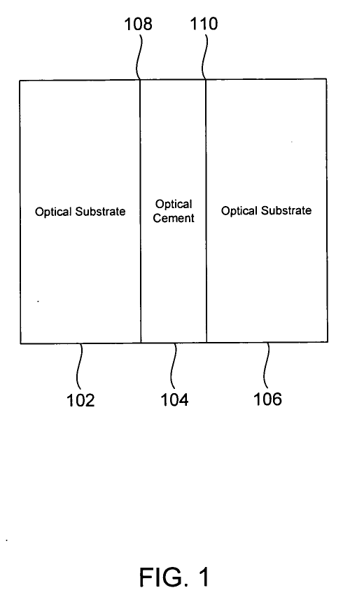

Optical cement is widely used in optical component bounding. For example, optical cement can be used with lenses, prisms, mirrors and similar components. FIG. 1 illustrates that optical cement 104 can be used in a digital projector to bind together two or more optical components, optical substrates, or glass lenses. Generally speaking, there are a limited number of optical cements (e.g., 3 to 5 types) that provide the desired results when used in combination with the many different types of glass in digital projectors and similar optical appliances. As a result, the interface of the optical cement with the digital projector glass produces higher light reflectance due to limited optical cement options available for picking workable optical cements in a projector. This means that it can be easier to optimize other optical components than it is to try to find optimal cement for a digital projector optical system.

In some instances two or more glasses need to be cemented together for optical performance reasons. In this combination, it can be desirable to use glasses that have a large index differential compared to each other and any cement, theoretical or real. In these instances additional help is necessary beyond a good cement index match so as to reduce ghosting to its lowest possible level while at the same time allowing the greatest possible freedom for the optical designer.

When a first optical substrate 102 has optical cement 104 applied to the substrate, then a bounding interface is created 108. A second bounding interface 110 may also created when a second layer of optical substrate 106 is bonded to the optical cement. This type of interface with only the optical substrates and optical cement can have an average reflectance of approximately 0.18% which can create light noise problems.

The substrate layers may be made of a fluorite containing glass. For example, the first substrate layer may be an optical glass that is a FPL53 type of glass or some other optical glass. The second substrate layer may be optical glass that is made of L-TIM28. Other types of optical glass may be used depending on the desired applications or properties for the optical components.

An embodiment is provided for an optical coating structure for a bounding interface between optical components. This optical coating structure creates a transition area between the optical substrates and the optical cement and can help provide a relatively low reflectance and tolerance insensitivity. Reducing the reflectance also reduces the amount of light that may otherwise be lost to the reflections. In other words, the multi-layer coating improves the phase matching between the multiple layers and can enable more light to pass through each interface while reducing reflections, ghosting, and optical noise.

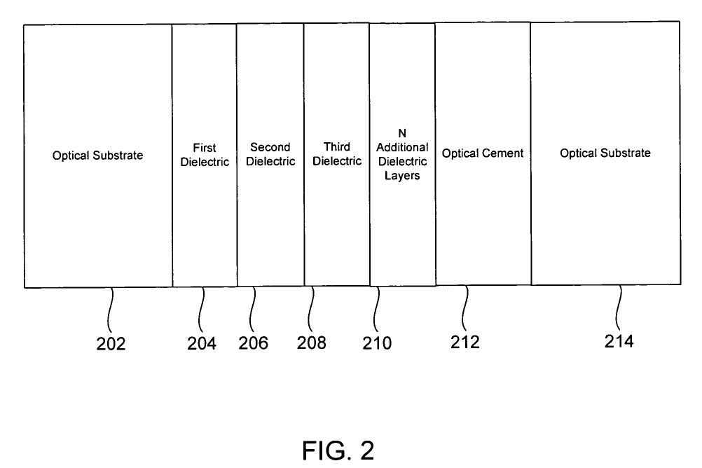

FIG. 2 illustrates a first optical substrate 202 having a substrate refractive index. This first optical substrate can be a glass lens, the end of an optical fiber, or another optically transmissive substrate. The glass lens can also be a fluorite containing glass. For example, the optical substrate can be an FPL51, FPL52, or FPL53 glass.

A first dielectric coating layer 204 can be applied to the first optical substrate 202. A second dielectric coating 206 can then be applied to the first dielectric coating layer, followed by a third dielectric coating 208 on the second dielectric coating layer. The dielectric layers can be applied by sputtering, evaporation, physical vapor deposition, or any other material layering technique known to those skilled in the art. The type of material used and the thickness of the dielectric materials affect the refractive index of each layer.

The use of three distinct dielectric layer material types (a separate type for each layer) helps to achieve ultra-low reflectance on the order of 0.02% to 0.018% and provide improved tolerance insensitivity in the optical coating. In one embodiment, the three or more dielectric materials can be arranged in an optical indices pattern of: a high index, a medium index, and low index (H-M-L) relative to the other dielectric layers. This arrangement is in contrast to the prior art that uses multiple sets of two dielectric materials with the optical indices pattern of a high index-low index, high index-low index, high index-low index, . . . , etc. The prior art used bounding interfaces that included at least 10 to 20 layers of the sets of two dielectric materials for the bounding interface.

The arrangement of H-M-L can also be reversed to (L-M-H) when the transition range between the substrate and the optical cement transitions in the reverse direction. This arrangement of H-M-L could be used in any order if needed (e.g., M-H-L) as long as the thickness of the different layers is altered to give the correct final result.

The combination of multiple optical indices and layer thicknesses produces the desired interface because the effective index of the combined layers provides the appropriate transition between the optical substrate and the cement layer. Three distinct material types for each of the dielectric layers can be selected, and then the optical influence for each layer can be modified by changing the respective thicknesses. The optical coating performance and tolerance is significantly improved when three or more dielectric materials are used in the bounding interface and their thickness is optimized for the 400 nm-700 nm light range. While more than 3 layers may be used 210, it is beneficial to use just three layers to reduce the overall cost of the coatings.

In addition, selected dielectric layers with effective optical indices that are close to the optical substrate and optical cement indices can reduce the reflectance of an uncoated surface by a factor of up to 100 times. The word “close” in this context generally means selecting a dielectric layer that is within ˜0.2 of the optical index of the substrate or the optical cement.

There are a number of dielectric materials that can be effective in the dielectric layers for reducing reflections and other optical artifacts. These layers can be made of or include materials such as Aluminum Oxide, Barium Fluoride, Silicon Oxide, Calcium Fluoride, Magnesium Fluoride, Potassium Chloride, Lithium Fluoride, and BK7 Optical Glass. Using the materials in a three or more layer combination as described can reduce the reflectance by up to 10 times. This list of materials also illustrates that a number of dielectric layer material types can be used while only a few types of cement can be used. Thus, it is important to optimize the dielectric layers.

An optical cement layer 212 can then be bonded or applied to the third dielectric coating. The optical cement layer is used to bind the first substrate with the dielectric layers to the second substrate 214 or optical glass. The optical cement can have a thickness between 3 to 5 micrometers or greater and this is approximately 1000 times thicker than the dielectric layers which have a thickness measured in nanometers. Although the cement may be used in a thinner layer, the use of thicker cement layers (3-5 micrometers) will increase the bonding force and helps avoid the situation where the optical cement acts as a thin film and creates an undesirable interface in the visible light region.

As discussed, the bounding interfaces can create a significant amount of reflectance due to Fresnel reflection. The reflected light can reduce the signal-to-noise ratio (SNR) in the desired optical output, as well as create light ghosting problems. The structures and methods for the embodiments described herein can reduce reflectance at the bounding interfaces.

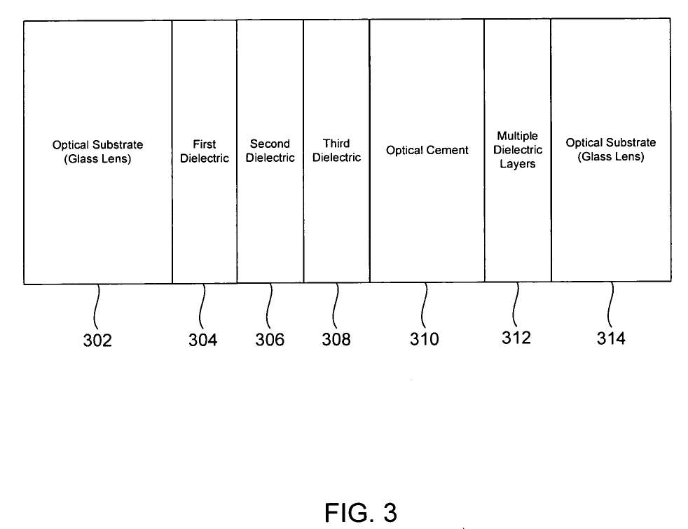

FIG. 3 illustrates that multiple dielectric layers 312 can also be applied to the second optical substrate 314, if desired. These additional layers or additional layer groups may have three or more dielectric layers as described above. Examples of the dielectric materials that can be used for dielectric layers include aluminum oxide, barium fluoride, or silicon oxide. The configuration illustrated in FIG. 3 provides optical transitions on each side of the optical cement 310.

One transition area is created for the first optical substrate 302 using the three dielectric layers 304, 306, 308, and the other layers are applied to the second optical substrate. This second layering area provides the optical transition structure for the second optical substrate with respect to the optical cement. The second optical substrate with its three dielectric layers may then be bonded to the first optical substrate using the cement layer. Additional dielectric layers may also be applied to the second optical substrate over and above the original three. These additional dielectric layers may be added in groups of three or singly as long as they contribute to the desired effective index of the base group of dielectric layers.

The refractive index of each group of three or more dielectric layers is selected in a specific way to optimize the interface between the substrates and the cement. Initially, a differential range is identified or defined. The differential range is represented by the difference between the refractive index values of the substrate refractive index and the cement refractive index. For instance, if the refractive index of a glass lens is 1.44 and the refractive index of the optical cement is 1.55 then the differential range is 1.44-1.55. This range represents the ideal region over which the dielectric coating layer indices should reside for good coating performance. When materials do not exist inside this range, then other materials outside this range may be chosen. However, the effective index or resulting effect of all the layers of the coating can be configured to lie in between the differential range. Furthermore, the order of optical indices for the three dielectric layers can vary where different optical indices can be produced by using different film thicknesses.

An example of one configuration of three dielectric layers using this method will now be discussed. A substrate layer or lens can be provided that has a refractive index of 1.44134. Three dielectric layers can be placed on top of the substrate layer. The first layer may be a Barium Fluoride layer that has a refractive index of 1.47957 and physical thickness of 76.71 nanometers. The second layer may be an Aluminum Oxide layer that has a refractive index of 1.6726 and a physical thickness of 13.78 nanometers. The third layer may be a Silicon Oxide layer that has a refractive index of 1.4618 and a physical thickness of 23.08 nanometers. These three dielectric layers can be located between an optical substrate, such as FPL53 and an optical cement that has a refractive index of 1.565.

The layer configuration of the example above uses three dielectric materials to achieve the desired optical performance and tolerance. In this layer configuration, the optical indices pattern is: medium index-high index-low index (M-H-L), and the combination of the optical indices provides an effective index between the substrate and the cement layer.

A second example embodiment can be a substrate layer or lens that has a refractive index of 1.70183. Three dielectric layers can be place on the substrate layers. The first layer may be an Aluminum Oxide layer that has a refractive index of 1.6726 and physical thickness of 76.77 nanometers, which results in an optical thickness of 0.251769. The second layer may be a Barium Fluoride layer that has a refractive index of 1.47957 and a physical thickness of 13.07 nanometers, which results in an optical thickness of 0.037931. The third layer may be another layer of Aluminum Oxide that has a refractive index of 1.6726 and a physical thickness of 21.76 nanometers, which results in an optical thickness of 0.071363. This second example uses three layers of two dielectric materials to achieve desired optical performance and tolerance. The optical indices pattern in this embodiment is H-L-H. These dielectric layers can be located between an optical substrate, such as L-TIM26, and an optical cement that has a refractive index of 1.565.

The first, second, and third dielectric coatings are then selected so that the combined effective index of the three or more coatings is within the differential range between the optical cement and the glass substrate or lens. This does not necessarily mean that the refractive index of each of the dielectric coatings is within the differential range but that the combined refractive index of the coatings provides an effective index that is within the differential range.

For example, the first coating refractive index may be located within the differential range, the second coating refractive index may be located outside the differential range, and then the third coating refractive index can be located within the differential range. The combination of the three coating can produce an effective coating refractive index that is within the differential range.

The embodiments described herein may reduce the reflectance across the bounding interfaces to 0.02% or less in visible region. While more than three layers of dielectric material may be used, it has been discovered that just three layers of dielectric material in the interface can produce the low levels of reflectance described. In addition, a reduced number of dielectric layers can be used as compared to prior art bounding interfaces that used 10 to 20 layers of the sets of two dielectric materials for the bounding interface.

Creating a combined refractive index that is between the refractive index of the substrate and the cement is important because it provides a smooth refractive index transition between the two components that have significantly different refraction amounts. The use of the three layers of dielectric that form a complex refraction co-efficient can provide an optical constant for the entire group of layers.

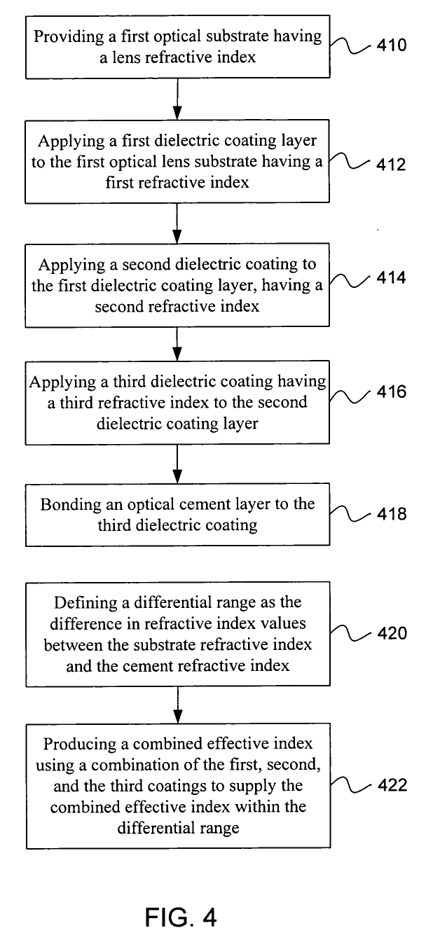

FIG. 4 illustrates a method for manufacturing an optical coating structure for optical components. The method includes the operation of providing a first optical substrate having a lens refractive index, as in block 410. The optical substrate may be a lens or optical glass.

A further operation in the method is applying a first dielectric coating layer to the first optical lens substrate, as in block 412. The dielectric layers can be applied using techniques such as vapor deposition, sputtering, and other deposition techniques known for applying thin layers of dielectric material.

A second dielectric coating can be applied to the first dielectric coating layer and a third dielectric coating can be applied to the second layer, as in blocks 414 and 416. Each layer may have its own refractive index depending on the material type used. For example, the first layer may be Barium Fluoride, the second layer may be Aluminum Oxide, and the third may be Silicon Oxide.

An optical cement layer can be bonded to the third dielectric coating, as in block 418. The optical cement layer is relatively thicker than the dielectric coating layers and has a different refractive index than the optical substrate or glass.

In addition to the steps described above, additional steps may be included as described in this paragraph and the following paragraph. A differential range may also be defined for the range of refractive index values between the refractive indices of the substrate and the cement, as in block 420. The differential range is the range between the refractive index values of the substrate refractive index and the cement refractive index. If the refractive index of the glass lens is 1.70 and the refractive index of the optical cement is 1.56, then the differential range is 1.70-1.56 for desired wavelength.

A combined effective refractive index may be produced using a combination of the first coating refractive index, the second coating refractive index, and the third coating refractive index to supply the combined effective index of the three layers within the differential range. This operation is illustrated in block 422. Because the combination of the three layers provides an effective refractive index that between the substrate (e.g., lens) and the cement indices, then a more gradual optical transition is created which reduces reflections and related optical problems.

These optical components and the dielectric layering can be used in an optical projector for the visible light spectrum (450 nm ˜650 nm), such as a Digital Mirror Device (DMD), or in other optical systems such as optical routers, optical computing components, or optical communication systems.

A method for using an optical lens having an optical coating structure may also be provided. The method includes the operation of providing a first optical substrate having a lens refractive index. A first dielectric coating layer can be applied to the first optical lens substrate. Then the second dielectric coating and a third dielectric coatings can be applied. Each layer will have its own refractive index. The combined layers form an optical combination with a refractive index between the optical lens and cement layer. The final operation is using the optical combination in an optical projector to reduce optical reflection.

It is to be understood that the above-referenced arrangements are only illustrative of the application for the principles of the present embodiments. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. An optical component with an optical coating structure for a bounding interface between optical components, comprising:
a first optical substrate having a substrate refractive index;
a first dielectric coating layer applied to the first optical substrate;
a second dielectric coating applied to the first dielectric coating layer;
a third dielectric coating applied to the second dielectric coating layer; and
an optical cement layer applied to the third dielectric coating.

2. An optical component as in claim 1, wherein at least two of the three dielectric materials are distinct dielectric materials used for the dielectric coatings to provide 0.02% reflectance or less.

3. An optical component as in claim 1, further comprising:
a second optical substrate;
a fourth dielectric coating layer applied to the second optical substrate;
a fifth dielectric coating applied to the first dielectric coating layer; and
a sixth dielectric coating applied to the second dielectric coating layer and bonded to the optical cement.

4. An optical component as in claim 1, wherein the optical cement is greater than 3 to 5 micrometers to create a non-thin film coating for 400 nm-700 nm wavelengths of light.

5. An optical component as in claim 1, wherein the first dielectric coating, second dielectric coating and third dielectric coating are each individually selected from the group consisting of: Aluminum Oxide, Barium Flouride, Silicon Oxide, Calcium Flouride, Magnesium Fluoride, Potassium Chloride, Lithium Fluoride, and BK7 Optical Glass.

6. An optical component as in claim 1, wherein the first dielectric coating is aluminum oxide, the second dielectric coating is barium fluoride, and the third dielectric coating is silicon oxide.

7. An optical component as in claim 3, wherein the fourth dielectric coating is aluminum oxide, the fifth dielectric coating is barium fluoride, and the sixth dielectric coating is silicon oxide.

8. An optical component with an optical coating structure for a bounding interface of optical components, comprising:
a first optical substrate having a substrate refractive index;
an optical cement layer having a cement refractive index, and a differential range defined by the range of refractive index values between the substrate refractive index and the cement refractive index;
a first dielectric coating located adjacent to the optical substrate and having a first coating refractive index;
a second dielectric coating adjacent to the first dielectric coating and having a second coating refractive index;
a third dielectric coating adjacent to the first dielectric coating and having a third coating refractive index; and
a combined effective index produced by a combination of the first coating refractive index, the second coating refractive index, and the third coating refractive index, wherein the combined effective index is located within the differential range.

9. An optical component as in claim 10, wherein the effective optical indices of each dielectric layer is within 0.2 of an optical index to the optical substrate and optical cement to reduce the reflectance.

10. An optical component as in claim 10, wherein the optical refractive indices of at least one of the dielectric layers can be outside the cement and substrate refractive indices, wherein a combination is chosen such that the combined effective index yields the effective index in the differential range.

11. An optical component as in claim 10, wherein the use of three distinct dielectric materials for the dielectric coatings provides 0.02% reflectance or less.

12. An optical component as in claim 10, further comprising a second optical substrate with third, fourth and fifth dielectric coatings bonded to the optical cement.

13. An optical component as in claim 10, wherein the optical cement is greater than 3 to 5 micrometers.

14. An optical component as in claim 10, wherein the first dielectric coating, second dielectric coating and third dielectric coating are selected from the group consisting of: Aluminum Oxide, Barium Flouride, Silicon Oxide, Calcium Flouride, Magnesium Fluoride, Potassium Chloride, Lithium Fluoride, and BK7 Optical Glass.

15. An optical component as in claim 10, wherein:
the first dielectric coating includes a first coating refractive index within the differential range;
the second dielectric coating includes a second coating refractive index outside the differential range; and
the third dielectric coating includes a third refractive index within the differential range.

16. An optical component with an optical coating structure for a bounding interface of an optical substrate, comprising:
a optical substrate means configured for transmitting light and having a substrate refractive index;
a first dielectric means for refracting light at a first refractive index, the first delectric coating means being adjacent to the optical substrate means;
a second dielectric means for refracting light at a second refractive index, the second dielectric coating being located adjacent to the first dielectric coating; and
a third dielectric means for refracting light at a third refractive index, the third dielectric means being located adjacent to the second dielectric coating;
an optical cement means for bonding to the third reflectance coating, wherein a combination of the first dielectric means, second dielectric means, and third dielectric means creates an effective refractive index for having a reduced reflection interface between the optical substrate means and the optical cement means.

17. A method for manufacturing an optical component with an optical coating structure for optical components, comprising the steps of:
providing a first optical substrate having an optical substrate refractive index;
applying a first dielectric coating layer to the first optical substrate having a first refractive index;
applying a second dielectric coating to the first dielectric coating layer, having a second refractive index;
applying a third dielectric coating having a third refractive index to the second dielectric coating layer; and
bonding an optical cement layer to the third dielectric coating.

18. A method as in claim 21, further comprising the steps of:
defining a differential range as the range of refractive index values between the substrate refractive index and the cement refractive index;
producing a combined effective index using a combination of the first coating refractive index, the second coating refractive index, and the third coating refractive index to supply the combined effective index within the differential range.

19. A method as in claim 20, further, comprising the steps of:
supplying a second optical substrate having a second refractive index;
applying a fourth dielectric coating layer applied to the second optical substrate;
applying a fifth dielectric coating to the fourth dielectric coating layer;
applying a sixth dielectric coating to the second dielectric coating layer; and bonding the second optical lens with the dielectric layers to the optical cement;
wherein the combined refractive indices of the fourth, fifth, and sixth dielectric coating layers combine to create an effective refractive index between the indices of the second optical substrate and the optical cement.

20. A method of using an optical lens having an optical coating structure, comprising the steps of:
providing a first optical substrate having a lens refractive index;
applying a first dielectric coating to the first optical lens substrate having a first refractive index;
applying a second dielectric coating to the first dielectric coating, having a second refractive index; and
applying a third dielectric coating having a third refractive index to the second dielectric coating layer to form an optical combination from the first, second and third dielectric coatings with a combined refractive index between the optical lens and cement layer;
using the optical combination in a projector to reduce optical reflectance.
